(19) United States
(12) Patent Application Publication
(10) Pub. No.: US 2005/0074670 A1
(43) Pub. Date: Apr. 7, 2005

(54) Lithium ion secondary cell

(76) Inventor: Hyo Azuma, Settsu-shi (JP)

Correspondence Address: BIRCH STEWART KOLASCH & BIRCH, PO BOX 747, FALLS CHURCH, VA, 22040-0747, US

(21) Appl. No.: 10/671,737

(22) Filed: Sep. 29, 2003

(30) Foreign Application Priority Data
Sep. 30, 2002 (JP) P2002-285154

(51) Int. Cl. H01M 4/58; H01M 4/62

(52) U.S. Cl. 429/231.8; 429/217

(57) ABSTRACT

A lithium ion secondary cell comprising a positive electrode, a negative electrode and a non-aqueous electrolytic solution wherein the negative electrode comprises a negative electrode active material containing a carbonaceous material having a spacing d₀₀₂ of 0.3360 nm or less, a crystal size Lc in the c-axis direction of at least 70 nm and a R value of from 0.01 to 0.3 where a R value is a ratio of I₁₃₅₀ to I₁₅₈₀ in which I₁₃₅₀ and I₁₅₈₀ are Raman intensities around 1350 cm⁻¹ and 1580 cm⁻¹ in a Raman spectrum, and wherein the non-aqueous electrolytic solution contains 0.5 to 5% by weight of vinylene carbonate or its derivative.

### BACKGROUND OF THE INVENTION

1. Field of the Invention

The present invention relates to a lithium ion secondary cell, which has a high capacity and good charge-discharge cycling properties.

2. Prior Art

In these years, secondary cells which can be repeatedly charged and discharged and have a high capacity are required with the progress of portable electronic equipments such as mobile phones, notebook type personal computers, etc. and also with the increase of attention to environments and resource-savings.

Nowadays, lithium ion secondary cells, which have a high energy density and a lightweight and can be miniaturized, are produced and used as secondary cells satisfying the above requirements. Such a lithium ion secondary cell comprises a lithium-containing complex metal oxide such as LiCoO₂, LiNiO₂ or LiMn₂O₄ as a positive electrode active material, and a carbonaceous material with which lithium can be intercalated or disintercalated as a negative electrode active material.

As a carbonaceous material to be used as a negative-electrode active material, one having a higher crystallinity is used in place of an amorphous one to further increase the energy density and achieve a higher voltage. Thus, JP-A-10-284081 discloses a lithium ion secondary cell comprising natural or artificial graphite having a high crystallinity as a negative electrode active material.

However, the carbonaceous material having a high crystallinity and a high capacity has a relatively large specific surface area of, for example, 2 to 8 m²/g. In the production of a negative electrode using such a carbonaceous material with a large specific surface area, when a fluororesin binder which can stabilize the electrode is used, it should be added to a negative electrode mixture in an amount of at least 5% by weight. Then, the filling rate of the active material decreases so that an energy density per unit weight decreases.

Furthermore, in the case of a cell comprising a carbonaceous material having a high capacity and a high crystallinity as a negative electrode active material, a solvent of an electrolytic solution tends to be decomposed on the surface of the negative electrode, and the degree of decomposition increases as the crystallinity of the carbonaceous material increases. Therefore, a gas is generated in the cell due to the decomposition of the solvent, and the gas generated increases the distance between the positive and negative electrodes. Consequently, the cycling properties of the cell deteriorate.

In addition, a non-aqueous electrolytic solution itself is improved to suppress the decomposition of the solvent of the electrolytic solution. Then, JP-A-2001-52737 discloses a non-aqueous electrolytic solution comprising at least two solvents selected from fluorine-containing ethers, unsaturated ethers and unsaturated esters, wherein vinylene carbonate or its derivative is used as an unsaturated ether or an unsaturated ester.

However, users require lithium ion secondary cells having a higher capacity and further improved charge-discharge cycling properties. To satisfy such requirements, an investigation was made to improve the cycling properties of a lithium ion secondary cell comprising a highly crystalline carbonaceous material as a negative electrode active material. Then, it was found that the effect of the addition of vinylene carbonate or its derivative to the electrolytic solution greatly depends on the surface properties of the highly crystalline carbonaceous material, and that the effect of the addition of the vinylene carbonate or its derivative appears only with a carbonaceous material having specific surface properties and such an effect greatly depends on the content thereof in the electrolytic solution, that is, the intended effect is achieved only when a small amount of the vinylene carbonate or its derivative is added to the electrolytic solution.

### SUMMARY OF THE INVENTION

One object of the present invention is to provide lithium ion secondary cell which can solve the problems associated with the conventional secondary cells and has a high capacity and excellent charge-discharge cycling properties.

Accordingly, the present invention provides a lithium ion secondary cell comprising a positive electrode, a negative electrode and a non-aqueous electrolytic solution wherein said negative electrode comprises a negative electrode active material containing a carbonaceous material having a spacing d₀₀₂ of 0.3360 nm or less where the spacing d₀₀₂ is a plane distance of (002) planes measured by a X-ray diffraction method, a crystal size Lc in the c-axis direction of at least 70 nm and a R value of from 0.01 to 0.3 where a R value is a ratio of I₁₃₅₀ to I₁₅₈₀ in which I₁₃₅₀ and I₁₅₈₀ are Raman intensities around 1350 cm⁻¹ and 1580 cm⁻¹ in a Raman spectrum measured by exciting a carbonaceous material with an argon laser having a wavelength of 514.5 nm, and wherein said non-aqueous electrolytic solution contains 0.5 to 5% by weight of vinylene carbonate or its derivative.

### BRIEF DESCRIPTION OF THE DRAWING

FIG. 1A is a plan view of one embodiment of a lithium ion secondary cell according to the present invention, and FIG. 2B is a partially cross sectional view of the lithium ion secondary cell of FIG. 1A.

FIG. 2 is a perspective view of the lithium ion secondary cell of FIG. 1.

### DETAILED DESCRIPTION OF THE INVENTION

In the present invention, the negative electrode active material contains a carbonaceous material, which has a spacing d₀₀₂ of 0.3360 nm (d₀₀₂≦0 0.3360), a crystal size Lc of at least 70 nm (Lc≧70 nm), and a R value of from 0.01 to 0.3 (0.01≦0.3).

Examples of such a carbonaceous material include natural graphite and artificial graphite. The artificial graphite may be the calcined materials of organic materials, which can be produced by calcining cokes, preferably cokes having a purity of at least 99%, celluloses, etc, or graphite prepared by heating glassy carbon, and the like. The above specific carbonaceous material may be used in admixture with other carbonaceous material.

When the carbonaceous material has a spacing d₀₀₂ of (002) planes of 0.360 nm or less, it has high crystallinity. When the spacing d₀₀₂ exceeds 0.360 nm, the crystallinity of the carbonaceous material decreases and thus the high capacity of may not be achieved. Therefore, a smaller spacing d₀₀₂ is advantageous from the viewpoint of the achievement of the high capacity, and the carbonaceous material having a spacing d₀₀₂ of about 0.3354 nm, which is the theoretical limit of the spacing d₀₀₂, may be used.

With the carbonaceous material, a Lc of at least 70 nm means a high crystallinity. Thus, when Lc is less than 70 nm, the carbonaceous material has a low crystallinity and the cell cannot have a high capacity. As Lc increases, the crystallinity of the carbonaceous material increases. Therefore, the larger Lc is favorable to the larger capacity of the cell.

In the present invention, the cell can have a high capacity of 350 mAh/g or larger, only when the spacing d₀₀₂ is 0.3360 nm or less and Lc is at least 70 nm.

Furthermore, the carbonaceous material to be used as a negative electrode active material according to the present invention has a R value of 0.01 to 0.3. When the R value is within this range, the cell has the improved charge-discharge cycling properties. When the R value is larger than 0.3 the crystallinity of the carbonaceous material increases inside the particles and also on the particle surfaces, so that the particles tend to be cracked when the cell is repeatedly charged and discharged. Thus, a protecting layer, which will be explained below, may not be formed at some areas of the particle surfaces. Therefore, the effect of the addition of vinylene carbonate or its derivative may not last long so that the charge-discharge cycling properties may deteriorate. As the R value decreases, the carbonaceous material has the increased ability to decompose the solvent of the electrolytic solution. Therefore, when the R value is less than 0.01, the solvent of the electrolytic solution may be decomposed in spite of the addition of vinylene carbonate or its derivative, and the gas generated increases the distance between the electrodes so that the charge-discharge cycling properties of the cell tend to deteriorate. When the R value is in the range of 0.1 to 0.3, the effect of the addition of vinylene carbonate or its derivative is remarkable.

In the present invention, the effect of the addition of the carbonaceous material having the above properties is larger with natural graphite than with artificial graphite.

The negative electrode may usually be produced as follows:

Firstly, the carbonaceous material and an optional binder are dispersed in a solvent to prepare a negative electrode mixture paste. The binder may be previously dissolved or dispersed in a solvent and then the carbonaceous material is added to the solution or dispersion. Then, the paste is applied on a negative electrode collector such as a copper foil and dried to form a negative electrode layer. Finally, the negative electrode layer may optionally be press-formed to obtain the negative electrode.

The negative electrode may be produced by any method other than the above-described method.

As a binder used in the formation of the negative electrode, cellulose ethers or rubber binders may be used. Examples of the cellulose ethers include carboxymethylcellulose, carboxyethylcellulose, hydroxyethylcellulose, their alkali metal salts (e.g. lithium salts, sodium salts, potassium salts, etc.) or their ammonium salts, and so on. Examples of the rubber binders include styrene-conjugated diene rubbers (e.g. styrene-butadiene rubbers (SBR), etc.), nitrile-conjugated diene rubbers (e.g. nitrile-butadiene rubber (NBR), etc.), silicone rubbers (e.g. polyorganosiloxane, etc.), polymers of alkyl acrylates, acrylic rubbers prepared by copolymerizing alkyl acrylates with ethylenically unsaturated carboxylic acids and/or other ethylenically unsaturated monomers, fluororubbers (e.g. vinylidene fluoride copolymers, etc.), and so on.

Preferably, the mixture of the cellulose ether and the rubber binder is used. In particular, the mixture of carboxymethylcellulose and a butadiene copolymer rubber such as styrene-butadiene rubber, nitrile-butadiene rubber, etc. is preferable. This is because the cellulose ether such as carboxymethylcellulose-increases the viscosity of the paste, while the rubber binder such as styrene-butadiene rubber binds the negative electrode mixture. When the mixture of carboxymethylcellulose and the butadiene copolymer rubber is used, a weight ratio of the former to the latter is preferably from 1:1 to 1:15.

The aqueous electrolytic solution used in the present invention contains 0.5 to 5% by weight of vinylene carbonate. The basic aqueous electrolytic solution to which vinylene carbonate is added is prepared by dissolving an electrolyte such as a lithium salt in a non-aqueous solvent such as an organic solvent.

The non-aqueous solvent may be any one of conventionally used solvent. Examples of the non-aqueous solvent include propylene carbonate (PC), ethylene carbonate (EC), dimethyl carbonate (DMC), methylethyl carbonate (MEC), tetrahydrofuran, y-butyrolactone, 1,2-dimethoxyethane(DME), etc. They may be used independently or as a mixture of two or more. In particular, a mixture of a cyclic carbonate such as proyplene carbonate or ethylene carbonate with a linear carbonate such as dimethyl carbonate or ethylmethyl carbonate is preferably used.

To prolong the charge-discharge cycling life of the cell, the cyclic carbonate is preferably contained in an amount of at least 10% by volume based on the whole volume of the solvent.

Examples of the electrolytic salt include LiPF₆, LiClO₄, LiBF₄, LiAsF₆, LiSbF₆, LiCₙF₂ₙ₊₁SO₃ (n≧1), LiCF₃CO₂, Li_{C}₂F₄(SO₃)₂, LiN(CF₃SO₂)₂, LiC (CF₃SO₂)₃, etc. They may be used independently or as a mixture of two or more. The concentration of the electrolytic salt in the electrblytic solution is not limited, and is preferably from 0.3 to 1.7 mol/liter.

In the present invention, the non-aqueous electrolytic solution contains vinylene carbonate or its derivative, since vinylene carbonate or its derivative may contribute to the formation of a stable protecting layer on the surface of the carbonaceous material in the negative electrode. That is, the protecting layer formed of vinylene carbonate or its derivative is a stable film which is not cracked during the charge-discharge cycles of the cell. When the negative electrode mixture is coated with such a protecting layer, the decomposition of the solvent of the electrolytic solution is prevented in the repeated charge and discharge and thus the generation of a gas is suppressed, when the highly active carbonaceous material having the high crystallinity such as natural or artificial graphite is used as the negative electrode active material. In addition, the protective film formed of vinylene carbonate or its derivative does not interfere with the normal reaction in the charge and discharge of the cell. Therefore, the cell has good charge-discharge cycling properties.

The amount of vinylene carbonate or its derivative is usually from 0.5 to 5% by weight, preferably from 1.2% by weight to 4% by weight, based on the whole weight of the non-aqueous electrolytic solution. When the amount of vinylene carbonate or its derivative is less than 0.5% by weight, the above effects may not be achieved. When the amount of vinylene carbonate or its derivative exceeds 5% by weight, an excessive amount of vinylene carbonate or its derivative, which does not contribute to the formation of the protecting film, is decomposed to generate the gas which expands the cell when the cell is stored at a high temperature.

A preferable derivative of vinylene carbonate is dimethyl-1,3-dioxol-2-one.

Vinylene carbonate or its derivative may be added to the non-aqueous electrolytic solution by adding it to the electrolytic solution which has been already prepared, or it may be added during the preparation of the non-aqueous electrolytic solution.

The non-aqueous electrolytic solution containing vinylene carbonate or its derivative is usually used in the liquid form, while it may be used in the form of a gel, which is prepared by adding a gelling agent to the electrolytic solution.

To make the protecting layer more favorable, the non-aqueous electrolytic solution may contain an additive, for example, a benzene derivative having an alkyl group such as butylbenzene, a benzene derivative having an alkoxyl group such as anisole, a fluorinated benzene such as fluorobenzene, an aromatic disulfide such as diphenyl disulfide, a cyclic sultone such as propanesultone, biphenyl, etc.

In the present invention, a positive electrode active material is preferably a lithium-containing complex metal oxide in view of the increase of the capacity. Preferable examples of such metal oxides include lithium-cobalt oxides (e.g. LiCoO₂, etc.), lithium-manganese oxides (e.g. LiMnO₂, LiMn₂O₄, etc.), lithium-nickel oxides (e.g. LiNiO₂, etc.), lithium-containing complex metal oxide of the formula: LiₓMO₂ wherein M represents at least two metals selected from Ni, Mn, Co and Al, and x is a number larger than 0.9 and smaller than 1.2 (0.9<x<1.2).

The positive electrode may be produced as follows:

To the above positive electrode active material, a conducting aid and/or a binder are optionally added to prepare a positive electrode mixture, and then the mixture is dispersed in a solvent to obtain a positive electrode mixture paste. The binder may be previously dissolved or dispersed in a solvent and then the positive electrode active material is added to the solution or dispersion. The positive electrode mixture paste is applied to a positive electrode collector and dried to form a layer of the positive electrode mixture, which is then optionally press-formed to obtain the positive electrode.

The positive electrode may be produced by any method other than the above method.

Examples of the conducting aid include carbon black, ketchen black, acetylene black, flake graphite, etc. Examples of the binder may be the same as those exemplified in connection with the negative electrode.

Examples of the collectors of the negative and positive electrodes include foils or nets of conductive metals such as aluminum, copper, nickel, stainless steel, etc.

As a separator to be inserted between the positive electrode and the negative electrode, a microporous resin film may be used. Examples of such a film include microporous polyethylene films, microporous polypropylene films, microporous ethylene-propylene copolymer films, microporous polypropylene-polyethylene two-ply films, microporous polypropylene-polyethylene-polypropylene three-ply films, and so on. The separator preferably has a thickness of 10 to 30 μm and a porosity of 30 to 60%.

### EXAMPLES

The present invention will be illustrated by the following Examples, which do not limit the scope of the invention in any way.

In the Examples, “parts” are “parts by weight”.

### Example 1

Natural graphite having a spacing d₀₀₂ of 0.3356 nm, Lc of 100 nm and a R value of 0.2 was used as a negative electrode active material. As a binder, a mixture of carboxymethylcellulose and a styrene-butadiene copolymer rubber in a weight ratio of 1:1 was used.

Natural graphite (98 parts) and the binder mixture (2 parts) were mixed in the presence of water to obtain a slurry paste containing the negative electrode mixture. Then, the paste was applied on the both surfaces of a negative electrode collector made of a copper foil having a thickness of 10 μm and dried to form the layer of the negative electrode mixture. This layer was compressed with rolls so that its density became 1.5 g/cm³. Then, the negative electrode sheet was cut to desired width and length to obtain a negative electrode.

Separately, a positive electrode was produced as follows:

LiCoO₂ (90 parts) as a positive electrode active material, carbon black (5 parts) as a conducting aid and polyvinylidene fluoride (5 parts) as a binder were mixed in N-methyl-2-pyrrolidone to prepare a positive electrode mixture paste. Then, this paste was applied on the both surfaces of a positive electrode collector made of an aluminum foil having a thickness of 15 μm and dried to form the layer of the positive electrode mixture. This layer was compressed with rolls to a desired thickness. Then, the positive electrode sheet was cut to designed width and length to obtain a positive electrode.

A non-aqueous electrolytic solution was prepared by dissolving LiPF₆ in a mixed solvent of ethylene carbonate and methylethyl carbonate (volume ratio of 1:2) in a concentration of 1.2 mol/liter. Then, 0.5% by weight of vinylene carbonate was added to the solution.

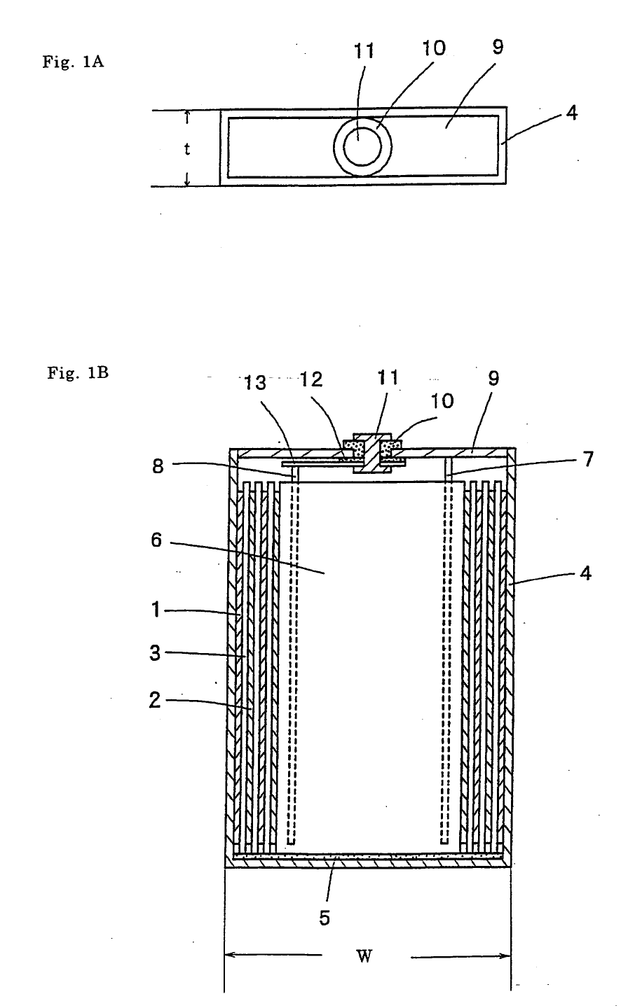

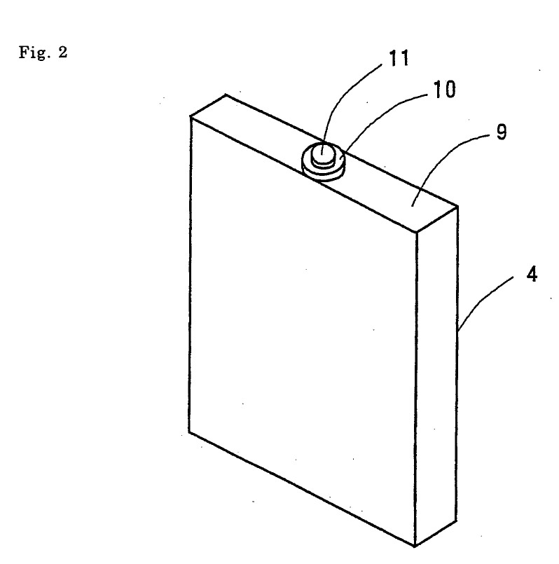

The positive and negative electrodes produced in the above steps were spirally wound with inserting a separator made of a microporous polyethylene film having a thickness of 25 μm and a porosity of 42% between the electrodes and then pressed to form a flat-form wound electrode laminate. Then, the wound electrode laminate was installed in a box-shaped cell case made of an aluminum alloy. Lead members were welded to the respective electrodes, and a lid plate was laser welded to the opening edge of the cell case. Through a pouring hole provided in the lidplate, the non-aqueous electrolytic solution containing vinylene carbonate was poured in the cell case, and the hole was sealed after the separator and the like were thoroughly impregnated with the electrolytic solution. After that, the cell was precharged and aged to obtain a box-shaped lithium ion secondary cell having a width of 34.0 mm, a thickness of 4.0 mm and a height of 50.0 mm, which had a-structure shown in FIGS. 1A and 1B, and an exterior shown in FIG. 2.

Now, the cell shown in FIGS. 1 and 2 is explained.

Positive electrode 1 and negative electrode 2 are spirally wound with inserting separator 3 between them and pressed to form flat-form wound electrode laminate 6, which is installed in cell case 4 together with a non-aqueous electrolytic solution. For simplicity, FIGS. 1A and 1B do not show metal foils used as the collectors of positive electrode 1 and negative electrode 2, and the electrolytic solution. In FIG. 1B, the inner part of electrode laminate 6 is not cross-sectioned. In general, an electrolyte layer comprises a separator and an electrolytic solution impregnated in the separator.

Cell case 4 is usually formed of a metal such as an aluminum alloy, and functions as an exterior member of the cell. Cell case 4 also functions as the terminal of the positive electrode.

At the bottom of cell case 4, insulator 5, which is usually made of a synthetic resin such as polytetrafluoroethylene, is provided.

Lead member 7 for a positive electrode and lead member 8 for a negative electrode are connected with positive electrode 1 and negative electrode 2, respectively, and drawn from flat-form wound electrode laminate 6 consisting of positive electrode 1, negative electrode 2 and separator 3. Metal terminal 11 is attached to metal lid plate 9 which seals the opening of cell case 4 through insulation packing 10. With terminal 11, metal lead plate 13 is attached through insulator 12. Usually, the metal terminal is made of stainless steel, the lid plate is usually made of an aluminum alloy, the insulation packing is made of a synthetic resin such as polypropylene, and the lead plate is made of stainless steel. Furthermore, lid plate 9 is inserted in the opening of cell case 4, and the mated parts of the lid plate and cell case are welded to close the opening of cell case 4 so that the interior of the cell is sealed.

In FIG. 1, lead member 7 for a positive electrode is welded directly with lid plate 9 so that cell case 4 and lid plate 9 together function as the terminal of the positive electrode, while leadmember 8 for negative electrode is welded to lead plate 13 and lead member 8 and terminal 11 are electrically connected with lead plate 13 so that terminal 11 functions as the terminal of the negative electrode. However, depending of the material of cell case 4, the terminals may function reversely.

FIG. 2 schematically shows the exterior of the cell of FIG. 1, and shows that the cell of this Example is a box-shaped cell. With this cell, the width is indicated by “W” in FIG. 1B, and the thickness is indicated by “t” in FIG. 1A.

In the case of this cell, the positive electrode is connected with a positive electrode terminal via the lead member of the positive electrode, while the negative electrode is connected with a negative electrode terminal via the lead member of the negative electrode. Thus, a chemical energy generated in the cell can be withdrawn outside as an electric energy.

### Example 2

A lithium ion secondary cell of this Example was produced in the same manner as in Example 1 except that the content of vinylene carbonate in the non-aqueous electrolytic solution was changed to 1% by weight.

### Example 3

A lithium ion secondary cell of this Example was produced in the same manner as in Example 1 except that the content of vinylene carbonate in the non-aqueous electrolytic solution was changed to 3% by weight.

### Example 4

A lithium ion secondary cell of this Example was produced in the same manner as in Example 1 except that the content of vinylene carbonate in the non-aqueous electrolytic solution was changed to 5% by weight.

### Example 5

A lithium ion secondary cell of this Example was produced in the same manner as in Example 3 except that natural graphite having a R value of 0.3 was used.

### Example 6

A lithium ion secondary cell of this Example was produced in the same manner as in Example 3 except that natural graphite having a R value of 0.01 was used.

### Example 7

A carbonaceous material used as a negative electrode active material was prepared as follows:

Artificial graphite was prepared from petroleum cokes having a spacing d₀₀₂ of 0.3365 nm, Lc of 70 nm and an average particle size of 19 μm. This graphite was calcined at 3000° C. for at least 20 minutes to obtain artificial graphite having a spacing d₀₀₂ of 0.3356 nm, Lc of 70 nm and a R value of 0.2.

A lithium ion secondary cell of this Example was produced in the same manner as in Example 3 except that artificial graphite produced in the above steps was used as a negative electrode active material.

### Comparative Example 1

A lithium ion secondary cell of this Comparative Example was produced in the same manner as in Example 1 except that no vinylene carbonate was added to the non-aqueous electrolytic solution.

### Comparative Example 2

A lithium ion secondary cell of this Comparative Example was produced in the same manner as in Example 1 except that the content of vinylene carbonate in the non-aqueous electrolytic solution was changed to 0.3% by weight.

### Comparative Example 3

A lithium ion secondary cell of this Comparative Example was produced in the same manner as in Example 1 except that the content of vinylene carbonate in the non-aqueous electrolytic solution was changed to 6% by weight.

### Comparative Example 4

A lithium ion secondary cell of this Comparative Example was produced in the same manner as in Example 3 except that natural graphite having a R value of 0.35 was used.

### Comparative Example 5

A lithium ion secondary cell of this Comparative Example was produced in the same manner as in Example 3 except that natural graphite having a R value of 0.08 was used.

### Comparative Example 6

A carbonaceous material used as a negative electrode active material was prepared as follows:

Artificial graphite was prepared from petroleum cokes having a spacing d₀₀₂ of 0.3365 nm, Lc of 60 nm and an average particle size of 19 μm. This graphite was calcined at 3000° C. for at least 20 minutes to obtain artificial graphite having a spacing d₀₀₂ of 0.3356 nm, Lc of 60 nm and a R value of 0.2.

A lithium ion secondary cell of this Comparative Example was produced in the same manner as in Example 3 except that artificial graphite produced in the above steps was used.

### Comparative Example 7

A lithium ion secondary cell of this Comparative Example was produced in the same manner as in Example 3 except that artificial graphite, which was produced from crosslinked petroleum pitch and had a spacing d₀₀₂ of 0.3652 nm, Lc of 1.9 nm and a R value of 0.8, was used.

The properties of the carbonaceous materials and the contents of vinylene carbonate are summarized in Table 1.

TABLE 1

| | Carbonaceous material | | | Content of |
|---|---|---|---|---|
| Example | d₀₀₂ | Lc | | vinylene carbonate |
| No. | (nm) | (nm) | R value | (wt. %) |
| Ex. 1 | 0.3356 | 100 | 0.2 | 0.5 |
| Ex. 2 | 0.3356 | 100 | 0.2 | 1 |
| Ex. 3 | 0.3356 | 100 | 0.2 | 3 |
| Ex. 4 | 0.3356 | 100 | 0.2 | 5 |
| Ex. 5 | 0.3356 | 100 | 0.3 | 3 |
| Ex. 6 | 0.3356 | 100 | 0.01 | 3 |
| Ex. 7 | 0.3356 | 70 | 0.2 | 3 |
| C. Ex. 1 | 0.3356 | 100 | 0.2 | 0 |
| C. Ex. 2 | 0.3356 | 100 | 0.2 | 0.3 |
| C. Ex. 3 | 0.3356 | 100 | 0.2 | 6 |
| C. Ex. 4 | 0.3356 | 100 | 0.35 | 3 |
| C. Ex. 5 | 0.3356 | 100 | 0.008 | 3 |
| C. Ex. 6 | 0.3356 | 60 | 0.2 | 3 |
| C. Ex. 7 | 0.3652 | 1.9 | 0.8 | 3 |

With the cells produced in Examples and Comparative Examples, a discharge capacity, a retention rate of a capacity after 500 cycles, and a thickness of the cell after being stored at 60° C. for 20 days were measured. The results are shown in Table 2.

The above properties of the cells were measured as follows:

Discharge Capacity

A discharge capacity was measured by allowing a cell to continuously discharge to 3.0 V at 25° C. at a current density of 750 mA.

Retention Rate of Discharge Capacity After 500 Cycles:

A cell was charged to 4.2 V at 25° C. at a current density of 750 mA. Then, the cell was charged at a constant voltage of 4.2 V for 2.5 hours from the start of charging. After that, the cell was discharged to 3.0 V at a current density of 750 mA. Such charge and discharge were repeated for 500 cycles. Thereafter, a retention rate of a discharge capacity after 500 cycles in comparison with a discharge capacity after the first cycle was calculated according to the following equation:
Retention rate of capacity=[(discharge capacity after 500 cycles)/(discharge capacity after the first cycle)]×100

Thickness of a Cell After Being Stored at 60° C. for 20 Days

A cell was charged to 4.2 V at 25° C. at a current density of 750 mA, and the cell was stored at 60° C. for 20 days. Thereafter, the thickness of the cell was measured at 25° C.

TABLE 2

| | | Retention of | |
|---|---|---|---|
| | Discharge | discharge capacity | Cell thickness |
| Example | capacity | after 500 cycles | after storage |
| No. | (mAh) | (%) | (mm) |
| Ex. 1 | 800 | 76 | 4.50 |
| Ex. 2 | 800 | 82 | 4.50 |
| Ex. 3 | 800 | 90 | 4.50 |
| Ex. 4 | 800 | 80 | 4.60 |
| Ex. 5 | 800 | 88 | 4.54 |
| Ex. 6 | 800 | 80 | 4.60 |
| Ex. 7 | 800 | 75 | 4.60 |
| C. Ex. 1 | 800 | 50 | 5.18 |
| C. Ex. 2 | 800 | 55 | 5.16 |
| C. Ex. 3 | 800 | 70 | 5.00 |
| C. Ex. 4 | 800 | 65 | 4.88 |
| C. Ex. 5 | 800 | 67 | 4.70 |
| C. Ex. 6 | 740 | 66 | 5.06 |
| C. Ex. 7 | 680 | 71 | 4.81 |

As can be seen from the results in Tables 1 and 2, the cells of Examples 1-7 according to the present invention had the large discharge capacity, that is, the high capacity, and the retention rate of capacity of 75% or larger, that is, good charge-discharge cycling properties. In addition, those cells suffered from less expansion after being stored at a high temperature.

In contrast, the cell of Comparative Example 1 containing no vinylene carbonate in the non-aqueous electrolytic solution and the cell of Comparative Example 2 containing only 0.3% by weight of vinylene carbonate in the non-aqueous electrolytic solution had poor charge-discharge cycling properties and suffered from large expansion after being stored at a high temperature.

The cell of Comparative Example 3 containing 6% by weight of vinylene carbonate in the non-aqueous electrolytic solution also had poor charge-discharge cycling properties. Furthermore, the cell of Comparative Example 4 which comprised the carbonaceous material having a R value of 0.35 and the cell of Comparative Example 5 which comprised the carbonaceous material having a R value of 0.008 had poor charge-discharge cycling properties.

The cell of Comparative Example 6 which comprised the carbonaceous material having Lc of 60 nm had a smaller capacity than the cells of Examples 1-7, and poor charge-discharge cycling properties. The cell of Comparative Example 7 which comprised the carbonaceous material having a spacing d₀₀₂ of 0.3652 nm had a smaller capacity than the cells of Examples 1-7.

Comparing the cell of Example 3 comprising natural graphite and that of Example 7 comprising artificial graphite, the former achieved better results than the latter. This means that natural graphite can more easily achieves the effects of the present invention than artificial graphite.

1. A lithium ion secondary cell comprising a positive electrode, a negative electrode and a non-aqueous electrolytic solution wherein said negative electrode comprises a negative electrode active material containing a carbonaceous material having a spacing d₀₀₂ of 0.3360 nm or less where the spacing d₀₀₂ is a plane distance of (002) planes measured by a X-ray diffraction method, a crystal size Lc in the c-axis direction of at least 70 nm and a R value of from 0.01 to 0.3 where a R value is a ratio of I1350 to I1580 in which I1350 and I1580 are Raman intensities around 1350 cm⁻¹ and 1580 cm⁻¹ in a Raman spectrum measured by exciting a carbonaceous material with an argon laser having a wavelength of 514.5 nm, and wherein said non-aqueous electrolytic solution contains 0.5 to 5% by weight of vinylene carbonate or its derivative.

2. The lithium ion secondary cell according to claim 1, wherein said carbonaceous material is natural graphite.

3. The lithium ion secondary cell according to claim 2, wherein said natural graphite has a R value of 0.1 to 0.3.

4. The lithium ion secondary cell according to claim 1, wherein said non-aqueous electrolytic solution contains 1.2 to 4% by weight of vinylene carbonate or its derivative.

5. The lithium ion secondary cell according to claim 1, wherein said negative electrode comprises a mixture of a cellulose ether compound and a butadiene copolymer rubber as a binder.
